(19) United States
(12) Patent Application Publication
(10) Pub. No.: US 2010/0271477 A1
(43) Pub. Date: Oct. 28, 2010

(54) Spray Angle Measurement Apparatus and Method

(76) Inventors: Dino J. Farina, Holliston, MA (US); Matthew D. Dombach, Belmont, MA (US); Timothy R. L'Ecuyer, Jefferson, MA (US); Zachary W. Pitluk, New Haven, CT (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/725,749

(22) Filed: Mar. 17, 2010

Related U.S. Application Data
(60) Provisional application No. 61/210,287, filed on Mar. 17, 2009.

(51) Int. Cl. H04N 7/18

(52) U.S. Cl. 348/135; 348/E07.085

(57) ABSTRACT

Direction of material emitted from orifices is directly related to the effectiveness of spray devices to deliver the material to an intended location area. Improper emission direction results in material, such as medication, paint, or fuel, not reaching its intended target and causes cascading effects, such as improper patient dosing, compromised patient relief, waste, poor target coverage, missed target penetration, poor engine performance, and other safety/performance problems. An apparatus for inspecting operation of an orifice according to an example embodiment measures actual material emission direction relative to an expected material emission direction determined as a function of position and orientation of an orifice. The apparatus may confirm whether the emission direction is within an expected emission direction and accepted tolerance range. Through use of the apparatus, accurate screening of production products can be performed efficiently and manufacturing defects can be diagnosed and eliminated.

### RELATED APPLICATION(S)

This application claims the benefit of U.S. Provisional Application No. 61/210,287, filed on Mar. 17, 2009, the entire teachings of which are incorporated herein by reference.

### BACKGROUND OF THE INVENTION

A position and orientation of an orifice is a contributing factor to the effectiveness of delivering material to be emitted via the orifice to where it is intended (i.e., the target location). For example, an improper emission direction due to improper position and orientation of the orifice results in the material not reaching its intended target location. Failure to reach the target location causes cascading effects that diminish the performance of the emitted material, including, for example, improper dosing (in the case of an inhaled medication), waste, poor target coverage, missed target penetration, poor engine performance (in the case of a fuel injector, for example), or other safety and/or performance problems. Additionally, an improper emission direction, due either to misalignment or improper operation of the orifice, can lead to erroneous results when the orifice is tested with systems that require the orifice to emit the material in a specific direction (e.g., cascade impaction particle sizing systems, dose collection systems, and in-line nozzle monitoring systems). Root causes for improper emission direction include, for example, manufacturing defects in the molding or machining process of the orifice or structure such as a nozzle or end of a pipe, defining the orifice; improper assembly of the structure defining the orifice, nozzle, or pump components; improper operation of the orifice's actuation system; or a combination of these or other causes.

### SUMMARY OF THE INVENTION

While existing methods and systems for emission measurements assist with characterization of emitted material (e.g., the spray) from orifices defined by structures (e.g. nozzles), the measurements do not capture actual material emission direction relative to the orifices, and, hence are incomplete for assessing the performance of the orifices. Further, none of the systems assess whether the measured emission direction matches an expected emission direction within an acceptable tolerance range.

Embodiments of the present invention improve performance and safety of emitted materials from orifices defined by structures (e.g., nozzles) by measuring actual material emission direction relative to an expected emission direction from an orifice and, optionally, confirming that the measured emission direction matches the expected emission direction within an expected tolerance.

Some embodiments quantify the direction (e.g., angle) of materials emitted from orifices defined by structures, such as nozzles or ends of pipes, to assess orifice performance. Other embodiments simply qualify the direction, such as by signaling as a pass or fail result.

One example embodiment of the present invention includes an orifice actuation system, such as a nasal spray pump system, that supports a structure defining an orifice in a position and orientation to cause material to be emitted from the orifice in its normal operating state, and also includes an emission inspection subsystem, such as a non-invasive illumination subsystem and sensor, configured to inspect the operation of the orifice by determining whether the material in a state of emission is in an expected emission direction.

In some embodiments, the orifice center is viewable by the emission inspection subsystem. In embodiments in which the orifice center is not viewable by the emission inspection subsystem, at least one fiducial mark for precisely locating the orifice center may be employed in a manner that does not disturb the normal operation of the orifice or the emission of material therethrough. The at least one fiducial mark may be in the same viewing plane as the orifice's center so that the physical location of the at least one fiducial mark relative to the orifice center is simplified to a two-dimensional (2D) planar offset, alternatively a more complicated three-dimensional (3D) offset may be employed.

In a configuration of an embodiment of the present invention, the non-invasive illumination subsystem and sensor include a planar laser and camera configured to measure the in-plane location of the emitted material at a pre-selected distance from the orifice and orthogonal to the expected emission direction. For sprays, this configuration is commonly referred to as “spray pattern” because the result is a measurement of the cross-sectional uniformity of the spray. Some geometrically relevant aspect of the inplane location of the emitted material (e.g., centroid) may be used to calculate the trajectory (i.e., direction) of the emitted material relative to the orifice's center and, further, this measured trajectory may be compared with the expected emission direction on a vector basis.

In an embodiment employing at least one fiducial mark a corresponding method may include: (a) collecting a calibrated image of the at least one fiducial mark; (b) using the calibrated image as precise reference point(s) for the at least one fiducial mark; and (c) determining the resultant position vector, whose direction is the angle between the measured trajectory of the emitted material and the expected emission direction.

In another embodiment of the present invention, a fiducial mark may be integrated into a holder configured to support the orifice during operation. In another embodiment of the present invention, the fiducial mark is separate from the holder, and the fiducial mark is optionally affixed to the orifice actuation system, if employed.

The fiducial mark may be selected from a group consisting of: a light emitting diode (LED), phosphorescent material appearing under certain lighting conditions, or light with associated light-pipe.

The fiducial mark may be configured to reflect or absorb a measurable signal with multiple contrast levels. The fiducial mark may have a geometry selected from a group consisting of: a circle, square, higher order polygon, cross-hairs, or non-symmetrical shape.

In an embodiment of the present invention with multiple fiducial marks, the multiple fiducial marks are positioned within an observation view of the orifice emission measurement subsystem at known position and orientation offsets relative to an expected position and orientation of the orifice. In this embodiment, the orifice emission measurement subsystem is further configured to calculate the expected emission direction as a function of the multiple fiducial marks.

In another embodiment of the present invention, the orifice emission measurement subsystem is further configured to observe the material in a state of emission and to calculate a vector representing an emission direction relative to an expected emission direction based on the position and orientation of the orifice to inspect the operation of the orifice.

In another embodiment of the present invention, the orifice emission measurement subsystem is further configured to change a viewing angle relative to the orifice to observe its position before or after material is emitted from the orifice and to calculate the emission direction based on the observation of the orifice and the material in the state of emission.

In another embodiment of the present invention, a fiducial measurement subsystem is configured to observe a position and orientation of a fiducial mark, having known position and orientation offsets from the orifice, and configured to report a measurement of the fiducial mark to the orifice emission measurement subsystem for use in calculating the vector.

In another embodiment of the present invention, the orifice actuation system is further configured to require a particular position and orientation of the orifice or not require it but, instead, observe the position and orientation and still further configured to report the position and orientation of the orifice to the orifice emission measurement subsystem for use in calculating the vector.

In another embodiment of the present invention, the orifice emission measurement subsystem is further configured to observe an intersection of a non-invasive illumination field and the material in the state of emission and still further configured to determine whether the material in the state of emission is in the expected emission direction, optionally by determining an emission vector as a function of the intersection.

In another embodiment of the present invention, a non-invasive illuminator is configured to produce the non-invasive illumination field, the non-invasive illuminator being, mechanically or electrically, coupled to the orifice actuation system or the orifice emission measurement subsystem.

In another embodiment of the present invention, a non-invasive illuminator is configured to produce the non-invasive illumination field in an optical spectrum at one or more positions at which the intersection is considered to be an indication of a departure from the expected emission direction, the orifice emission measurement subsystem further configured to observe optical scattering, absorption, or fluorescence at the intersection.

In another embodiment of the present invention, the material is a liquid, gas, gel, aerosol, atomized liquid, solid, or powder.

In another embodiment, the present invention comprises a method for inspecting operation of an orifice, comprising supporting an orifice in a position and orientation and causing material to be emitted from an orifice in its normal operating state; and. determining whether the emitted material is in an expected emission direction.

In another embodiment of the present invention, determining whether the emitted material is in an expected emission direction further includes observing a fiducial mark at known position and orientation offsets relative to the orifice; and determining the position and orientation of the orifice based on observation of the fiducial mark.

In another embodiment of the present invention, observing the fiducial mark includes observing the fiducial mark on a holder configured to support the orifice during operation; and/or observing the fiducial mark separate from a holder configured to support the orifice during operation, the fiducial mark optionally affixed to an orifice actuation system to which the orifice is coupled during operation.

In another embodiment of the present invention, observing the fiducial mark includes observing light from: a light emitting diode (LED), phosphorescent material appearing under certain lighting conditions, or light-pipe.

In another embodiment of the present invention, observing the fiducial mark includes detecting reflection or absorption of a measurable signal with multiple contrast levels.

In another embodiment of the present invention, observing the fiducial mark includes identifying a geometry of the fiducial mark selected from a group consisting of: a circle, square, higher order polygon, cross-hairs, or non-symmetrical shape.

In another embodiment of the present invention, determining whether the material in a state of emission is in an expected emission direction further includes determining the position and orientation of the orifice based on observation of multiple fiducial marks having known position and orientation offsets relative to the orifice.

In another embodiment of the present invention, determining whether the material in a state of emission is in an expected emission direction further includes observing the material in a state of emission and calculating a vector representing an emission direction relative to an expected emission direction based on the position and orientation of the orifice, and further comprising observing a position and orientation of a fiducial mark., having known position and orientation offsets from the orifice, and reporting a measurement of the fiducial mark for use in calculating the vector, and further comprising observing a position and orientation of the orifice and using the position and orientation of the orifice in calculating the vector.

In another embodiment of the present invention, comprising observing an intersection of a non-invasive illumination field and the material in the state of emission and determining whether the material in the state of emission is in the expected emission direction, optionally further determining a vector representing the emission direction as a function of the intersection, and wherein the material is a liquid, gas, gel, aerosol, atomized liquid, solid, or powder.

In another embodiment of the present invention, a system for inspecting operation of an orifice comprises means for supporting an orifice in a position and orientation and causing a material to be emitted from an orifice in its normal operating state; and means for determining whether the material fluid in a state of emission is in an expected emission direction.

In another embodiment of the present invention, a method for inspecting operation of an orifice comprises observing a material in a state of emission from an orifice; and determining whether the material in the state of emission is in an expected emission direction, wherein determining whether the material in the state of emission is in an expected emission direction further includes calculating a vector representing an emission direction relative to an expected emission direction based on a position and orientation of the orifice.

In another embodiment of the present invention, an orifice emission measurement subsystem for inspecting operation of an orifice, comprises an observation module configured to observe a material in a state of emission from a orifice; and a determination module configured to determine whether the material in the state of emission is in an expected emission direction, wherein the determination module is further configured to calculate a vector representing an emission direction relative to an expected emission direction based on a position and orientation of the orifice.

In another embodiment of the present invention, independent of a camera and imaging system, an orifice actuation system is configured to inject fuel into an engine or turbine, such as those used in automobiles or other motor vehicles, or gas or steam turbines. In this embodiment, the at least one fiducial mark is optionally located on the orifice actuation system.

In another embodiment of the present invention, independent of a camera and imaging system, an orifice actuation system is configured for an inkjet print head. In this embodiment, the at least one fiducial mark may be located on the ink jet orifice actuation system.

In another embodiment of the present invention, independent of a camera and imaging system, the at least one fiducial mark may be located on the orifice of a projectile actuation system, such as a rifle.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram illustrating a system 100 for inspecting an operational state of an orifice to determine direction of emission from the orifice according to an example embodiment of the present invention;

FIG. 2 is a diagram of a setup of a camera configured to observe a viewing plane through which emission from an orifice passes;

FIG. 3 is a diagram illustrating a spray device holder with an integrated fiducial mark according to an example embodiment of the present invention;

FIG. 4 is a graphical diagram illustrating an illumination field for inspecting the operational state of an orifice according to an example embodiment of the present invention; and

FIG. 5 is a flow diagram of a method of determining an emission direction of material from an orifice in accordance with an example embodiment of the present invention.

### DETAILED DESCRIPTION OF THE INVENTION

A description of example embodiments of the invention follows.

Correct operation of spray devices is critical to effective and efficient use of the material emitted from the spray devices. Manufacturing defects in the molding or machining process, improper assembly of an orifice defined by a structure, nozzle, or pump components, improper operation of the orifice's actuation system, or a combination of these or other causes may result in improper emission direction of the material emitted from the orifice of the spray device. An embodiment of the present invention serves to inspect the operation of spray devices and, in particular, determine an emission direction of the material emitted from the spray device.

Existing systems address certain root causes for improper emission direction. For example, improper operation of the orifice's actuation system may be addressed through automated actuation. Automated actuation of manually operated spray devices, such as nasal spray pumps, may be employed to decrease variability in emitted material delivery due to operator factors (including removal of potential operator bias in actuation), and increase sensitivity for detecting potential differences among orifice and/or pump designs during testing. An appropriate automated actuation system may include settings for force, velocity, acceleration, length of stroke, and/or other relevant parameters suitable for the orifice and/or pump design's mode of operation. Such an automated actuation system is used to prevent improper emission direction caused by improper operation of the orifice's actuation system, but, while the automated actuation system is configured to control the emission direction, it is not configured to measure the emission direction.

Visual inspection may allow for detection of gross molding defects or improper assembly of orifices, nozzles, or pump components. However, unless molding defects or improperly assembled orifices, nozzles, or pump components are quite visibly misshaped or defective, defects may go unnoticed and impair the effectiveness of the emitted material, Further, visual inspection of a non-operating orifice, nozzle, or pump component does not measure emission direction during operation, which can provide more information than visual inspection alone.

Other systems produce measurements regarding certain characteristics of emitted material from orifices but, again, do not measure emission direction. For example, measurements of spray pattern characteristics of the emitted spray from orifices include measurements based on (i) physical impaction of the spray against a surface or, alternatively, (ii) digital imaging of the spray using optical techniques that employ laser light sheet illumination.

For purposes of describing embodiments herein, the term “orifice” is defined as an opening or aperture, as of a tube or pipe, and the term “nozzle” is defined as a projecting part with an opening, as at the end of a hose, for regulating and directing a flow of fluid.

An embodiment of the present invention employs an orifice actuation system that causes material to be emitted from the orifice and an emission measurement subsystem that inspects the operation of the orifice by determining whether the emitted material is emitted in an expected direction. A position of the orifice is the location of the orifice in one, two or three dimensions within a given coordinate system (e.g., Cartesian (x-y), cylindrical, or spherical), and the orientation of the orifice is the angular direction of the orifice in the given coordinate system.

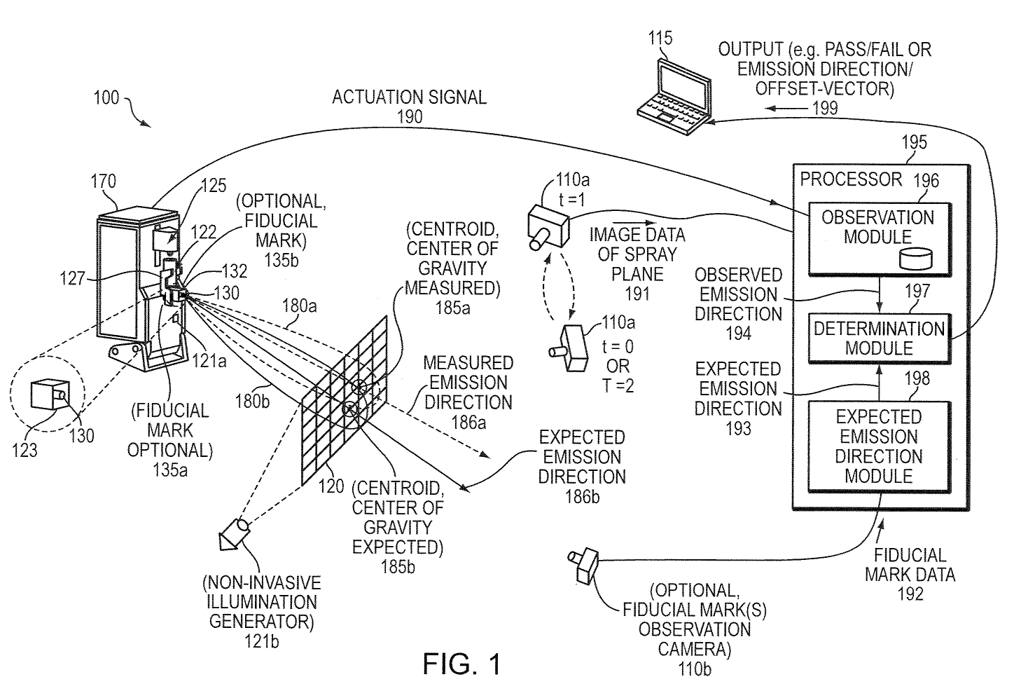

FIG. 1 is a diagram illustrating a system 100 for inspecting an operational state of an orifice 130 defined by a structure, such as a nozzle 123 according to an example embodiment of the present invention. The system 100 includes an orifice actuation system 170 alternatively, referred to in this description as an orifice actuation device 170 so as not to be confused with the system 100, that is used to actuate a material emitting device 125, such as a metered dose inhaler (MDI), to cause the inhaler to project material (e.g., medication), stored in a canister 122 through a nozzle 123 and out an orifice 130. The nozzle 123 and its orifice 130 may be obstructed from view by a mouthpiece 132 or other structure of the material emitting device 125. The material emitting device 125 may be affixed to the actuation device 170 via a material emitting device holder 127. The material emitting device holder 127 may also include an optional fiducial mark 135a that is at a known position and orientation offset from the orifice 130. Additional fiducial mark(s) 135b may be located on the actuation device 170 or holder 127 in this embodiment.

The example system 100 further includes a non-invasive illumination generator 121 that generates a non-invasive illumination plane 120. The non-invasive illumination generator 121 may be a planar laser that creates the non-invasive illumination plane 120 to illuminate material passing through the plane 120. The system 100 further includes a camera 110a configured to capture images or video of material that is illuminated at the non-invasive illumination plane 120.

Optionally, the system 100 may further include a second camera 110b for monitoring the fiducial mark(s) 135a-b. In addition, the system 100 includes a processor 195 comprising an observation module 196, determination module 197, and ‘expected emission direction’ calculation module 198. The processor 195 is configured to receive input/data from elements of the system 100, such as the orifice actuation device 170 and cameras 110a, 100b, and, using the data/input, to determine an emission direction of material emitted from the orifice 130. The processor 195 may receive captured image data 191 (e.g., illumination of a spray plume or other material emitted from the orifice 130) and/or fiducial mark data 192 from the cameras 110a-b. It should be understood that the processor 195 may be hardware, firmware, or software with the modules 196, 197, 198 being implemented in any combination thereof. In addition, the processor 195 may be located in its own assembly (not shown), in the actuation system 170, or in an external computing device 115 such as a laptop computer, desktop computer, or personal digital assistant (PDA), used in connection with the system 100.

The orifice actuation device 170 is configured to actuate the orifice 130 manually or automatically. Optionally, during operation, the actuation device 170 may send an actuation signal 190 to the processor 195 prior to actuation to alert the processor 195 to initiate collection of data via the camera(s) 110a-b. Upon actuation of the material emitting device 125, the camera 110a captures images of scattered light, absorbed light, or fluoresced light produced as a result of material that passes through the illumination plane 120. The illumination plane 120 is typically located at a predetermined distance from the orifice 130 of the material emitting device 125, but may be moved dynamically on angle or distance through known optical techniques, in some embodiments. The distance may be selected to match a distance that is typical for providing medication effectively via an inhaler or for coating a surface with paint by a spray painter. In that way, a measurement that mimics actual field use of the material emitting device 125 can be achieved.

Based on the illumination of the emitted material that passes through the illumination field, the processor 195 determines a measured emission direction 186a and compares it to an expected emission direction 186b. The expected emission direction 186b may be determined by imaging the fiducial mark(s) 135a-b, before or after the actuation of the material emitting device 125, and, based on the imaging of the fiducial marks, calculating an expected emission direction 186b. The fiducial mark(s) 135 may be located at known position and orientation offsets from the orifice, and, using the known offsets, the expected emission direction module 198 can calculate the expected emission direction.

The fiducial mark(s) 135a-b may be any form of fiducial mark, active or passive, that can be used for purposes described herein. For example, active fiducial marks can be in the form of a light emitting diode, phosphorescent material, or light radiating element with associated light pipe to project light, and the output of the active fiducial may be captured by a dedicated fiducial mark observation camera 110b. The camera 110b then sends the captured data image or video (i.e., fiducial mark data) 192 to the processor 195 to calculate the expected emission direction. This calculation may be done by calculating the direction of the light emitted by fiducial mark(s) 135a-b and then compensating for the known position and orientation offsets of the fiducial mark(s) 135a-b relative to the orifice 130. In this embodiment, the expected emission direction calculation module 198 calculates the expected emission direction 186b.

Alternatively, the expected emission direction 186b may be calculated without use of the fiducial mark(s) 135a, 135b. For example, the actuation device 170 may change its orientation via a swivel (not shown) such that the camera 110a has a direct line of sight of the orifice 130 and can take an image of the orifice before or after actuation of the orifice 130. In this embodiment, the camera 110a then sends the captured image 192 to the processor 195 and, in turn, the expected emission direction calculation module 198 processes the captured image 192 to determine the expected emission direction 186b. The expected emission direction module 198, using known image processing techniques, may determine the position and orientation of the orifice 130. After determining the position and orientation of the orifice 130, the expected emission direction module 198 may calculate the expected emission direction 186b with greater precision by considering actuation force, mass of material to be emitted, initial expected velocity of the material during emission, and other forces known to those skilled in the art for calculating a directional vector. In another embodiment, the camera 110a may change its orientation with respect to the orifice 130 and capture an image 192 of the orifice 130 before or after the actuation of the orifice 130. This latter embodiment is represented in FIG. 1 as t=0 or t=2 as corresponding to times.

During operation, the system 100 determines the emission direction of the material emitted from the material emitting device 125. Upon actuation of the orifice 130, the camera 110a captures illumination indications(s) (e.g., scattering, absorption, fluorescence) of the material emitted from the orifice 130 as it passes through the non-invasive illumination plane generated by the planar laser 121. The camera 110a sends the captured images or video 191 to the processor 195. The observation module 196 receives the data 191, converts it to a representation, such as a vector, that can be used by the determination module 197 for processing. The determination module 197 then calculates the emission direction of the material emitted from the orifice using the known position of the orifice and point or region of illumination in the illumination field. If the material is a solid object or projectile, the illumination is more similar to a point than region and used to determine the emission direction of the emitted material. However, if the material is a non-solid material and has multiple points, the illumination is more of a region than a point, and the determination module 197 may determine the centroid (or center of gravity) 185a of the multiple points or region of illumination and use this centroid location for calculating the emission direction.

Once the measured emission direction 186a of the material is calculated by the determination module 197, the determination module 197 may compare the measured emission direction 186a with the expected emission direction 186b calculated by the emission direction calculation module 198 and produce an output 199 representing the relationship between the two calculated directions, such as angle difference. Depending on the angle difference, the output 199 may be a pass/fail to a user monitoring system 100 via the computing device 115.

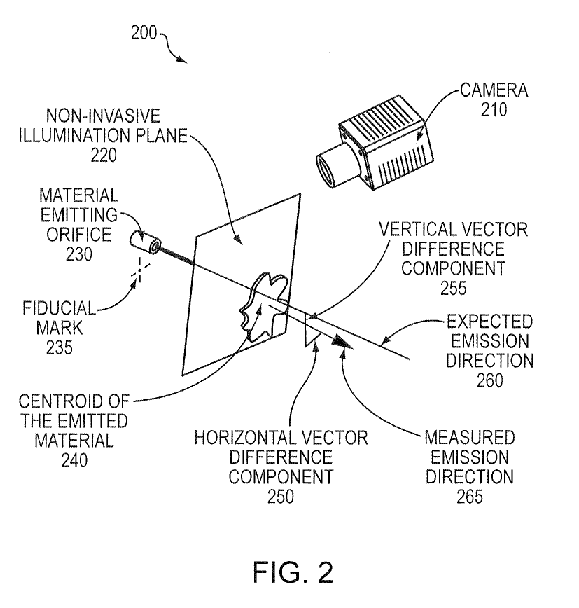

FIG. 2 is a diagram illustrating a system 200 for inspecting an operational state of an orifice according to an example embodiment of the present invention. Similar to the embodiment of FIG. 1, in the system 200 of FIG. 2, a camera 210 is used to capture the illumination of material passing through a non-invasive illumination plane 220. Based on the captured information, the system 200 calculates a centroid 240 of the emitted material and determines an emission direction 265 based on the location of the centroid and known position of the material emitting orifice 230.

In addition, the system 200 determines an expected emission direction 260, with or without the use of fiducial mark(s) 235. Using the calculated emission direction 265 and expected emission direction 260, the system 200 is able to determine a relationship between the two directions. For example, the difference in emission direction may include information such as a horizontal vector difference component 250 and a vertical vector difference component 255. Using this information, an angle of orifice orientation may also be determined. Further, the difference components may be characterized in quality assurance systems and used to determine possible errors in manufacturing of the material emitting orifice 230. Moreover, in at least one embodiment, the difference in emission direction in combination with features of the spray plume may be characterized, either individually or as an aggregate pair, and used to determine possible errors in manufacturing of the material emitting orifice 230. In other words, models can be created based on shape, emission direction, and other features of a spray plume and be used to identify particular manufacturing defects with the material emitting orifice 230 or elements associated therewith.

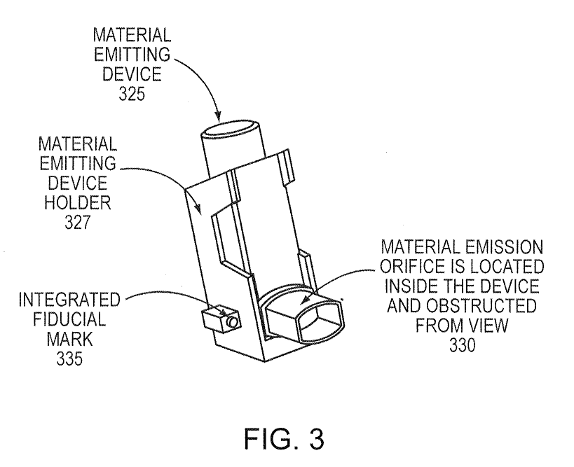

FIG. 3 is a diagram illustrating a spray device holder 327 with an integrated fiducial mark 335 according to an example embodiment of the present invention. The material emitting device holder 327 may be configured to hold a material emitting device 325 such that the orifice 330 of the material emitting device 325 are at known position and orientation offsets relative to the integrated fiducial mark 335. As illustrated, the integrated fiducial mark 335 is affixed to the holder such that it maintains a fixed position and orientation. Thus, the holder 327 is configured to hold a material emitting device after material emitting device 325 with the fiducial mark maintaining known position and orientation offsets relative to the orifice 330. The known offset information is useful in determining the emission direction of material emitted from the material emitting device, particularly in cases in which viewing obstruction of the orifice 330 is present.

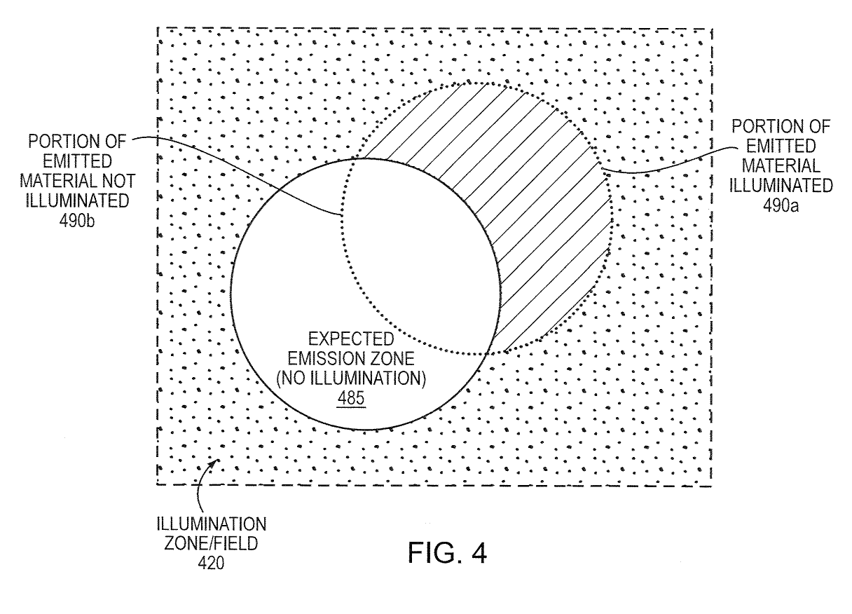

FIG. 4 is a graphical diagram illustrating an illumination field for inspecting the operational state of an orifice according to an example embodiment of the present invention. It should be understood that the operational state of the orifice includes before, after, or during operation or actuation of the orifice. As described above, a planar illumination field perpendicular or otherwise oriented relative to an expected path of travel may be used to illuminate material emitted from a material emitting device, and, based on the illumination, used to determine an emission direction of the emitted material. Alternatively, as illustrated in FIG. 4, a non-planar illumination field 420 may be employed and configured to illuminate material that diverges from an expected emission direction prematurely, where early illumination may indicate an error in position or orientation of the orifice. As illustrated, the illumination field 420 may surround an expected emission zone 485; emitted material within the expected emission zone 485 is not illuminated and, thus, indicates accurate position and orientation of an orifice. However, any illumination indicated an error in direction of the emitted material from an expected emission direction, which may be a result of an error in position or orientation of an orifice or of a manufacturing error. As illustrated in FIG. 4, a portion of emitted material 490a is illuminated and a portion of the emitted material 490b is not illuminated. This illumination pattern suggests that the emitted material almost reached its target distance, particularly since the illuminated portion 490a is up and to the right of the expected emission zone 485. Since gravity acts on emitted material, a pattern of illuminated material 490a slightly below the expected emission material in a sliver-of-the-moon pattern is possible but can be pre- or post-compensated, either by device(s) (not shown) producing the illumination field 420 or instrumentation or processor(s) used in measuring the direction of emitted material.

The illumination zone/field 420 may be a ring of laser light beams or other light source known to emit light that is scattered by, absorbed by, or causes fluorescence of the emitted material. The light source can be mechanically coupled to an actuation device 170 (FIG. 1), assembly supporting a camera 110a, 110b (FIG. 1), or other assembly.

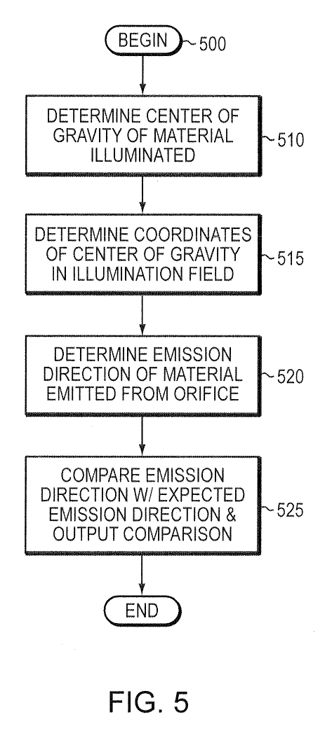

FIG. 5 is a flow diagram of a method of inspecting an operational state of an orifice in accordance with an example embodiment of the present invention. After the method begins (500), the centroid or center of gravity of material illuminated by a non-invasive illumination plane is determined (510). The coordinates of the centroid in relation to the illumination field is then determined (515). The emission direction can then be determined 510 using the determined location of the centroid of the emitted material. The determined emission direction is compared 525 with an expected emission direction to determine a result, which can be provided, in an observation report (not shown) to another system (e.g., an external computer 115 (FIG. 1)) or a user. A more detailed embodiment of the method of the flow diagram is provided below.

### EXEMPLIFICATION

The Proveris Scientific Corporation (Marlborough, Mass.) SprayVIEW® NMDI instrument is equipped with an automated orifice actuation subsystem, and a planar laser and camera for non-invasive inspection of nasal sprays and pharmaceutical Metered Dosage Inhaler (pMDI's) in accordance with Federal Drug Administration (FDA) recommendations, and is suitable for use with certain embodiments of the present invention. Additionally, Proveris's Viota® software platform, which is compatible with the SprayVIEW NMDI instrument, provides many of the required features for certain embodiments of the present invention (e.g., automatic image calibration and spray pattern detection) and can form the basis for a complete implementation of certain embodiments of the present invention with the addition of software necessary to calculate the emitted material direction, with or without fiducial mark(s), and compare it to the expected emitted direction.

The additional software functionality may be designed to perform the following functions:

1. Allow the entry of the relationship between the location of fiducial mark(s) and orifice center in dimensioned units (e.g., mm).

2. Allow the camera and planar laser to be set up for imaging the emitted material at a pre-selected distance relative to the orifice; allow the camera's field of view (“FOV”) to be calibrated in this configuration by using a calibration target; and to have the fiducial mark(s) or orifice visible within the camera's FOV in this configuration.

3. Collect a normal spray pattern image sequence as described in U.S. Pat. Nos. 6,665,421, 6,785,400, 6,973,199, and 7,463,751, the teachings of which are incorporated herein by reference in their entireties, and compute the in-plane location and centroid of the emitted material at a pre-selected distance from the orifice and orthogonal to the expected emission direction.

4. Calculate the centroid-to-orifice center position vector based on the data entered in function 1, and the calibrated image collected in function 3 above.

5. Calculate the difference between the measured and expected emitted material directions and optionally compare this value against acceptance criteria.

Operation of an embodiment of the invention can be performed as follows:

1. If necessary, attach the emission device to a device holder (with or without integrated fiducial mark or marks) as shown in FIG. 2.

2. If necessary, attach the device holder with emission device of Step 1 to the automated actuation instrument.

3. If using fiducial mark(s): enter the information necessary to define the relative location of the fiducial mark(s) and the orifice center; or else enter any required information to define the location of the orifice center,

4. Position the camera and non-invasive illumination plane in a spray pattern configuration as shown in FIG. 1.

5. Position the non-invasive illumination plane at a pre-selected distance from the orifice as shown in FIG. 1.

6. Focus the camera and calibrate its FOV on the imaging plane coincident with the plane of the planar laser.

7. Store the calibration information.

8. If using fiducial mark(s), present the fiducial mark(s) and collect an image from the camera; else collect an image of the orifice from the camera.

9. If using fiducial mark(s): hide the fiducial mark(s).

10. Turn on the planar laser and if necessary, arm the automated actuation system.

11. Actuate the device, if necessary, and/or collect all of the normal data associated with a spray pattern measurement (e.g., image sequence).

12. Apply the image calibration information from Step 7 above and other image correction arithmetic (e.g., perspective distortion correction, etc.) to calibrate the collected spray pattern image data and produce a representative spray pattern image of the emitted material.

13. Detect the center(s) of the fiducial mark(s) or orifice directly in image (i.e., pixel) coordinates.

14. Apply the image calibration information from Step 7 and other image correction arithmetic (e.g., perspective distortion correction, etc.) to convert the image coordinates of the fiducial mark(s) or orifice to dimensioned units (e.g., mm) and store the location(s).

15. If a single fiducial mark is used: shift the fiducial mark center location determined in Step 14 to the orifice center using the information supplied in Step 3 and store this location as the emitted material origin; If multiple fiducial marks are used: compute the logical center point of the fiducial marks and follow the preceding instructions for the single fiducial mark scenario; If fiducial mark(s) are not used: store the orifice center location as the emitted material origin.

16. Project the emitted material origin location from Step 15 above onto the calibrated spray pattern image from Step 12 above using common 3-D vector arithmetic and store this location as the spray pattern image reference origin.

17. Calculate the centroid location of the emitted material spray pattern and reference it to the spray pattern image reference origin determined in Step 16 above.

18. Calculate the position vector between the centroid location calculated in Step 17 and the emitted material origin calculated in Step 15, as shown in FIG. 1. The magnitude and direction of this position vector are the emission skew and emission direction, respectively, of the emitted material relative to the orifice center. Using these calculations, materials that are emitted in perfect alignment with the orifice result in a position vector that has an emission direction equal to zero and an emission skew equal to the distance between the orifice and the plane of the planar laser.

19. Optionally calculate the difference between the measured and expected emission directions and compare the difference to the acceptance criteria.

In an embodiment of the present invention when a fiducial mark or marks are employed, the fiducial mark(s) are designed to be present during the acquisition of a calibrated reference image and hidden while the material is being emitted from the orifice, This feature prevents introduction of any possibility of a false-positive being detected by the sensor of an orifice emission inspection subsystem during material emission from the orifice. The presence of the fiducial mark(s) may be controlled electronically (e.g., a fiducial mark itself can be a small light emitting diode “LED”, or an LED may drive light through a lightpipe whose exit creates the fiducial mark(s)), or the fiducial mark(s) can be made from a phosphorescent material that appears only under certain lighting conditions (e.g., visible during calibration, and invisible during orifice inspection), or the fiducial mark(s) can be removed from the orifice inspection data through a processing technique (e.g., an image processing technique designed to remove the mark(s) from the inspection data). The shape of the fiducial mark(s) is designed to allow the center of the fiducial mark(s) to be automatically detected in the calibrated reference image even if the fiducial mark(s) is out of focus. The location of the fiducial mark(s) is ideally in the same plane as the orifice as shown in FIG. 1. These latter two features allow the position vector calculation to be done solely based on the calibrated reference image and the physical location of the fiducial mark(s) relative to orifice.

While certain elements of the present disclosure are described as used to determine the emission direction of pharmaceutical spray devices, it should be understood that such elements may more broadly define a precision sensor and method that can be used to measure the emission direction of any type of material emitted from an orifice. Examples of other use applications include the following: directional characterization of household spray pumps, pressurized spray cans, pharmaceutical nasal syringes, oral and dermal therapeutic spray devices, projectile emission devices, industrial nozzles, cosmetic spray pumps, and/or fuel injection spray devices.

Embodiments of the device holder of the present invention may be used in applications where precision orientation of a spray device is required to interface the orifice to other instrumentation, such as robotic handling equipment, laboratory cascade impaction instruments, spray/dose sampling equipment, or other automated actuation instrumentation, or with patients needing training for proper device usage (e.g. respiratory therapy).

It should be understood that the methods, as illustrated by the flow diagrams or as described in reference to or understood with respect to the mechanical, electrical, schematic, or network diagrams, may be implemented in the form of hardware, firmware, or software. in the case of software, the software may be any language capable of performing the example embodiments disclosed herein or equivalent thereof or example embodiments understood in the art at the present time or later developed, or equivalents thereof, as understood from the teachings herein. Moreover, it should be understood that the software may be stored in any form of non-transitory computer-readable medium, such as Random Access Memory (RAM), Read-only Memory (ROM), Compact-Disk ROM (CD-ROM), optical or magnetic medium, as so forth. The software may be stored thereon as sequences of instructions and loaded and executed by processor(s), including general purpose or application specific processor(s) capable of executing the software in manner(s) disclosed herein or understood from the disclosed embodiments or equivalents thereof.

The teachings of all patents, published applications and references cited herein are incorporated by reference in their entireties.

While this invention has been particularly shown and described with references to example embodiments thereof, it will be understood by those skilled in the art that various changes in form and details may be made therein without departing from the scope of the invention encompassed by the appended claims. For example, the flow diagram of FIG. 5 can include more or fewer procedural blocks and include decision blocks. The illuminator pattern of FIG. 4 may have a shape different from the circular center shape shown or be inverse from itself (i.e,, the center illuminated and outside region non-illuminated or have a different color, pattern, polarization, or other optical quality). Further, in FIG. 1, additional light sources or optical elements, such as filters, collimators, and beam splitters, may be employed to achieve the measurements described in reference thereto.

What is claimed is:

1. An apparatus for inspecting operation of an orifice, comprising:
an orifice actuation system configured to support a structure defining an orifice in a position and orientation and cause material to be emitted from the orifice in an operating state; and
an orifice emission measurement subsystem configured to inspect operation of the orifice by determining whether the material in a state of emission is in an expected emission direction.

2. The apparatus of claim I wherein the structure defining the orifice is a nozzle.

3. The apparatus of claim 1 further comprising at least one fiducial mark positioned within an observation view of the orifice emission measurement subsystem at known position and orientation offsets relative to the position and orientation of the orifice.

4. The apparatus of claim 3 wherein the at least one fiducial mark is integrated into a holder configured to support the orifice during operation.

5. The apparatus of claim 3 wherein the at least one fiducial mark is separate from a holder configured to support the structure defining the orifice during operation, the at least one fiducial mark optionally affixed to the orifice actuation system.

6. The apparatus of claim 3 wherein the orifice is unobservable by the measurement subsystem, and wherein the orifice emission measurement subsystem is further configured to determine the position and orientation of the orifice based on observation of the at least one fiducial mark.

7. The apparatus of claim 3 wherein the at least one fiducial mark is selected from a group consisting of: a light emitting diode (LED), phosphorescent material appearing under certain lighting conditions, or light with associated light-pipe.

8. The apparatus of claim 3 wherein the at least one fiducial mark is configured to reflect or absorb a measurable signal with multiple contrast levels.

9. The apparatus of claim 3 wherein the at least one fiducial mark has a geometry selected from a group consisting of: a circle, square, higher order polygon, cross-hairs, or non-symmetrical shape.

10. The apparatus of claim 1 further comprising multiple fiducial marks positioned within an observation view of the orifice emission measurement subsystem at known position and orientation offsets relative to an expected position and orientation of the orifice and wherein the orifice emission measurement subsystem is further configured to calculate the expected emission direction as a function of the multiple fiducial marks.

11. The apparatus of claim 1 wherein the orifice emission measurement subsystem is further configured to observe the material in a state of emission and to calculate a vector representing an emission direction relative to an expected emission direction based on the position and orientation of the orifice to inspect the operation of the orifice.

12. The apparatus of claim 11 wherein the orifice emission measurement subsystem is further configured to change a viewing angle relative to the orifice to observe its position before or after the orifice emits the material and to calculate the emission direction based on the observation of the orifice and the material in the state of emission.

13. The apparatus of claim 11 further including a fiducial measurement subsystem configured to observe a position and orientation of a fiducial mark, having known position and orientation offsets from the orifice, and configured to report a measurement of the at least one fiducial mark to the orifice emission measurement subsystem for use in calculating the vector.

14. The apparatus of claim 11 wherein the orifice actuation system is further configured to require or observe a position and orientation of the orifice and still further configured to report the position and orientation of the orifice to the orifice emission measurement subsystem for use in calculating the vector.

15. The apparatus of claim 1 wherein the orifice emission measurement subsystem is further configured to observe an intersection of a non-invasive illumination field and the material in the state of emission and still further configured to determine whether the material in the state of emission is in the expected emission direction, optionally by determining an emission vector as a function of the intersection.

16. The apparatus of claim 15 further including a non-invasive illuminator configured to produce the non-invasive illumination field, the non-invasive illuminator being coupled to the orifice actuation system or the orifice emission measurement subsystem.

17. The apparatus of claim 15 further including a non-invasive illuminator configured to produce the non-invasive illumination field in an optical spectrum at one or more positions at which the intersection is considered to be an indication of a departure from the expected emission direction, the orifice emission measurement subsystem further configured to observe optical scattering, absorption, or fluorescence at the intersection.

18. The apparatus of claim 1 wherein the material is a liquid, gas, gel, aerosol, atomized liquid, solid, or powder.

19. A method for inspecting operation of an orifice, comprising:
supporting a structure defining an orifice in a position and orientation and causing material to be emitted from the orifice in an operating state; and
determining whether the material in a state of emission is in an expected emission direction.

20. The method of claim 19 wherein supporting the structure defining the orifice includes supporting a nozzle.

21. The method of claim 19 wherein determining whether the material in a state of emission is in an expected emission direction further includes:
observing at least one fiducial mark at known position and orientation offsets relative to the orifice; and
determining the position and orientation of the orifice based on observation of the at least one fiducial mark.

22. The method of claim 21 wherein observing the at least one fiducial mark includes:
observing the at least one fiducial mark on a holder configured to support the orifice during operation; or
observing the at least one fiducial mark separate from a holder configured to support the orifice during operation, the at least one fiducial mark optionally affixed to an orifice actuation system to which the structure defining the orifice is coupled during operation.

23. The method of claim 21 wherein observing the at least one fiducial mark includes observing light from: a light emitting diode (LED), phosphorescent material appearing under certain lighting conditions, or light-pipe.

24. The method of claim 21 wherein observing the at least one fiducial mark includes detecting reflection or absorption of a measurable signal with multiple contrast levels.

25. The method of claim 21 wherein observing the at least one fiducial mark includes identifying a geometry of the at least one fiducial mark selected from a group consisting of: a circle, square, higher order polygon, cross-hairs, or non-symmetrical shape.

26. The method of claim 19 wherein determining whether the material in a state of emission is in an expected emission direction further includes determining the position and orientation of the orifice based on observation of multiple fiducial marks having known position and orientation offsets relative to the orifice.

27. The method of claim 19 wherein determining whether the material in a state of emission is in an expected emission direction further includes observing the material in a state of emission and calculating a vector representing an emission direction relative to an expected emission direction based on the position and orientation of the orifice.

28. The method of claim 27 further comprising observing a position and orientation of at least one fiducial mark, having known position and orientation offsets from the orifice, and reporting a measurement of the at least one fiducial mark for use in calculating the vector.

29. The method of claim 27 further comprising observing a position and orientation of the orifice and using the position and orientation of the orifice in calculating the vector.

30. The method of claim 19 further comprising observing an intersection of a non-invasive illumination field and the material in the state of emission and determining whether the material in the state of emission is in the expected emission direction, optionally further determining a vector representing the emission direction as a function of the intersection.

31. The method of claim 19 wherein the material is a liquid, gas, gel, aerosol, atomized liquid, solid, or powder.

32. A system for inspecting operation of an orifice, comprising:
means for supporting a structure defining an orifice in a position and orientation and causing material to be emitted from the orifice in an operating state; and
means for determining whether the material fluid in a state of emission is in an expected emission direction.

33. A method for inspecting operation of an orifice, comprising:
observing material in a state of emission from an orifice; and
determining whether the material in the state of emission is in an expected emission direction.

34. The method of claim 33 wherein determining whether the material in the state of emission is in an expected emission direction further includes calculating a vector representing an emission direction relative to an expected emission direction based on a position and orientation of the orifice.

35. An orifice emission measurement subsystem for inspecting operation of an orifice, comprising:
an observation module configured to observe material in a state of emission from an orifice; and
a determination module configured to determine whether the material in the state of emission is in an expected emission direction.

36. The orifice emission measurement subsystem of claim 35 wherein the determination module is further configured to calculate a vector representing an emission direction relative to an expected emission direction based on a position and orientation of the orifice.
